(19) United States
(12) Patent Application Publication
(10) Pub. No.: US 2016/0121773 A1
(43) Pub. Date: May 5, 2016

(54) CLIP FOR FIXING MAT OF VEHICLE CARPET

(71) Applicant: DAEHAN SOLUTION CO., LTD, Incheon (KR)

(72) Inventor: Choong Ho KWON, Seoul (KR)

(73) Assignee: DAEHAN SOLUTION CO., LTD, Incheon (KR)

(21) Appl. No.: 14/891,709

(22) PCT Filed: Oct. 29, 2014
(86) PCT No.: PCT/KR2014/010238

§ 371 Date: Nov. 17, 2015

(30) Foreign Application Priority Data
Nov. 14, 2013 (KR) 10-2013-0138108

(51) Int. Cl. B60N 3/04

(52) U.S. Cl. CPC B60N 3/046

(57) ABSTRACT

A clip for fixing a mat of a carpet of a vehicle in which the clip is easily and rapidly mountable on the carpet such that assemblability is improved by forming the clip to be directly fixed to the carpet in a cable tie manner as a wing section is rotated, and the coupling force is improved by preventing the clip mounted on the carpet once from being detached. The clip further enhances the coupling force fixing the clip to the carpet to prevent the coupling force of the clip from being weakened or the clip from being detached even when the external force is applied to the carpet, by forming the clip so that the coupling force in the cable tie type is enhanced to further enhance the coupling force of the clip as the carpet is pressed on the mat.

### TECHNICAL FIELD

The present invention relates to a clip for fixing a mat of a carpet of a vehicle, and more particularly, to a clip that is formed to be directly fixed to the carpet in a cable tie type when a tongue section is rotated such that the clip can be easily mounted on the carpet and assembled, and is firmly able to be fixed so that the clip is not detached from the carpet due to an improved coupling force of the clip even if the carpet or the mat is pressed while a mounting force of the clip is enhanced to prevent the clip from being detached from the carpet.

### BACKGROUND ART

In general, when mats are used by being additionally mounted on carpets in a vehicle, clips for fixing the mats are fixedly installed on the carpet, and the mats are fixed by being hooked to the clips. Patent Documents 1 and 2 disclose configurations of clips used to fix mats on carpets in this way.

Patent Document 1 relates to a clip for fixing a mat on a carpet of a vehicle, and discloses the clip that includes a lower plate that is located on a lower surface of the carpet and has insertion grooves formed in a front section; an upper plate that is located on an upper surface of the carpet and has hooks to be fastened to the insertion grooves formed in a front section thereof and a protrusion to which the mat is fitted formed in a upper part thereof; a column that passes through a hole of the carpet and vertically connects a rear section of the lower plate and a rear section of the upper plate; and a pressing unit that is formed by a flexible material to enhance a fixing force of the clip to the carpet by pressing the carpet section fitted between the upper plate and the lower plate upward when the upper plate and the lower plate are fastened, has an annular longitudinal sectional surface, and by which the upper part and the lower part gradually come closer to each other when the upper plate and the lower plate are fastened.

Patent Document 2 relates to a vehicle carpet reinforcing structure which reinforces a vehicle carpet to be fixed with a mat using a fixing clip, and a method of manufacturing the same. The vehicle carpet reinforcing structure includes a body that is located to correspond to a lower part of the fixing clip and has a plate shape body; and a fixing unit installed on one side of the body to fix the body to the carpet. According to the vehicle carpet reinforcing structure and method of manufacturing the same of Patent Document 2, by reinforcing the carpet to correspond to a bottom surface of the fixing clip for fixing the mat, it is possible to suppress the damage or deformation of the carpet due to the movement of the fixing clip and to extend the lifetime of the carpet.

However, such conventional clips have the following problems:

(1) Since the clip is configured by being divided into the upper plate and the lower plate, it was inconvenient to mount the clip on the carpet;

(2) Since the clip is fixed to the carpet in the form of an elastic piece, when a weak impact is applied to the clip, the elastic piece is easily unfixed, and the clip may be detached from the carpet;

(3) The mat fixed to the clip deviates from its original position due to the detachment of the clip, and there is an inconvenience in that the mat is required to be fixed at its original position again or repositioned;

(4) When the clip is frequently unhooked or does not work due to damage or the like, since there is a need to replace the clip with a new one, there is an inconvenience in maintenance;

(5) In particular, since the fixing unit of the clip made in the form of the elastic piece loses elasticity over time, ultimately, the clip may be detached from the carpet; and

(6) Since the elastic piece has a form in which it is hooked on only one side, when loads are applied to the clip from several directions, the clip is easily unhooked, and the clip may be detached from the carpet.

Patent Document 1 Korean Patent No. 10-0971253 (registration date: Jul. 13, 2010)

Patent Document 2 Korean Patent No. 10-1210463 (registration date: Dec. 4, 2012)

### DISCLOSURE

### Technical Problem

The present invention is directed to providing a clip for fixing a mat of a carpet of a vehicle in which the clip is easily and rapidly mountable to the carpet such that assemblability is improved by forming the clip to be directly fixed to the carpet in a cable tie type as a wing section is rotated, and the coupling force is improved by preventing the clip mounted on the carpet once from being detached.

In particular, the present invention is directed to providing a clip for fixing a mat of a carpet of a vehicle which further enhances the coupling force fixing the clip to the carpet to prevent the coupling force of the clip from being weakened or the clip from being detached even when external force is applied to the carpet, by forming the clip so that the coupling force in the cable tie type is enhanced to further enhance the coupling force of the clip as the carpet is pressed downward on the mat.

Furthermore, the present invention is directed to providing a clip for fixing a mat of a carpet of a vehicle that can be doubly and more firmly mounted on the carpet in a tie coupling manner and a coupling operation of a hooking jaw, by causing the hooking operation through the hooking jaw to act in a section connecting the rotary fixing section and the tongue section.

### TECHNICAL SOLUTION

One aspect of the present invention provides a clip for fixing a mat of a carpet of a vehicle including a body 100, one side of which has a hook 110 formed to hook the mat M, and the other side of which has a fastener 200 to be fixed by being fitted to the carpet C and a plurality of pressing protrusions 120 configured to contact the carpet C, wherein the fastener 200 includes a rotation support section 210 inserted into a mounting hole H1 formed through the carpet C at a predetermined position; a fixing section 220 that is inserted into another mounting hole H2 formed to pass through the carpet C with a predetermined gap from the mounting hole H1, protrudes toward the outside of the mounting hole H2, and is formed with a plurality of hooking jaws 221 to be hooked in one direction; and a tongue section 230 that is formed in the rotation support section 210 to be rotatable toward the fixing section 220, and has a through-hole 231 having an elastic piece 231 a at a tip thereof, the elastic piece being elastically deformed so that the hooking jaws 221 advance by being sequentially hooked.

In particular, as the tongue section 230 is mounted by being fitted to the fixing section 220, hooking jaws 211 and 235 may be formed on surfaces of the rotation support section 210 and the tongue section 230 that face each other, and when the through-hole 231 of the tongue section 230 is mounted by being fitted to the hooking jaw 211, the hooking jaws 211 and 235 may be coupled to each other.

In addition, unlocking of the elastic piece 231 a is enabled by cutting both side surfaces of the through-hole 231 through which the hooking jaw 221 passes to pass therethrough so that the elastic piece 231 a is viewed from the outside.

Further, the tongue section 230 may be formed integrally with the rotation support section 210, and may be rotated by being connected by a weakened section 232 having a thin thickness.

Finally, the tongue section 230 may have a pressing piece 234 that is further formed on a surface that faces the carpet C to be pressed in contact with the carpet C.

### Advantageous Effects

According to the clip for fixing the mat of the carpet of the vehicle of present invention, there are the following effects:

(1) Since the clip can be mounted on the carpet only by the operation of rotating the tongue section, it is possible to simplify an assembling process of the clip;

(2) Since a direction of the coupling section coupled in a cable tie manner is the same as a direction in which an external force is applied from above the carpet, it is possible to prevent the clip from being easily detached even if a load is applied from above the carpet;

(3) As the clip is fitted to one side like a cable tie, the coupling force is continuously enhanced to prevent the clip from being easily detached from the carpet;

(4) Since the detachment of the clip is prevented in this manner, it is possible to maintain a position of hooking the mat and mounting the clip;

(5) When a load is applied from above the carpet, the tongue section is pressed and more firmly fixed to the fixing section to enhance the coupling force of the clip;

(6) Since the elastic piece is exposed to the outside while enhancing the coupling force with the carpet, it is possible to release the coupling force of the clip by a simple operation of tilting it;

(7) Thus, when the clip is damaged and replaced with a new one or the carpet or the like is exchanged, the clip can be easily attached and detached;

(8) Since the clip is mounted on the carpet through the coupling of the cable tie type and the coupling type of the pressing protrusions and the hooking jaws in a double locking manner, it is possible to prevent the clip from being easily detached; and

(9) Since the clip is integrally manufactured, the clip is easily manufactured, and the assembling process can be omitted. Accordingly, the clip can be mass-produced.

### DESCRIPTION OF DRAWINGS

FIG. 1 is a cross-sectional view illustrating a state in which a clip is mounted on a carpet and then a mat is fitted thereon to describe a configuration of a clip according to the present invention.

FIG. 2 is a cross-sectional view illustrating a state in which the clip according to the present invention is inserted into a mounting hole to mount the clip to a carpet.

FIG. 3 is a cross-sectional view illustrating a state in which a tongue section is fitted and fixed to a fixing section while the clip according to the present invention is fitted to the mounting hole.

FIG. 4 is a cross-sectional view illustrating a state in which the clip according to the present invention is mounted on the carpet and the mat is mounted on the clip.

### MODES OF THE INVENTION

Hereinafter, exemplary embodiments of the present invention will be described in greater detail. However, the terms or words used in the specification and claims are not to be interpreted by their typical or dictionary meanings but their meanings and concepts should be construed in conformity with the technical idea of the invention, based on the principle that the inventor can properly define the concepts of the terms to explain the invention in the best manner.

Therefore, since the exemplary embodiments described herein and the configurations illustrated in drawings are merely the most preferred embodiments of the present invention and are not intended to limit all the technical ideas of the present invention, it should be understood that there may be variations, equivalents or modifications capable of replacing them at the time of filing of this application.

### Configuration

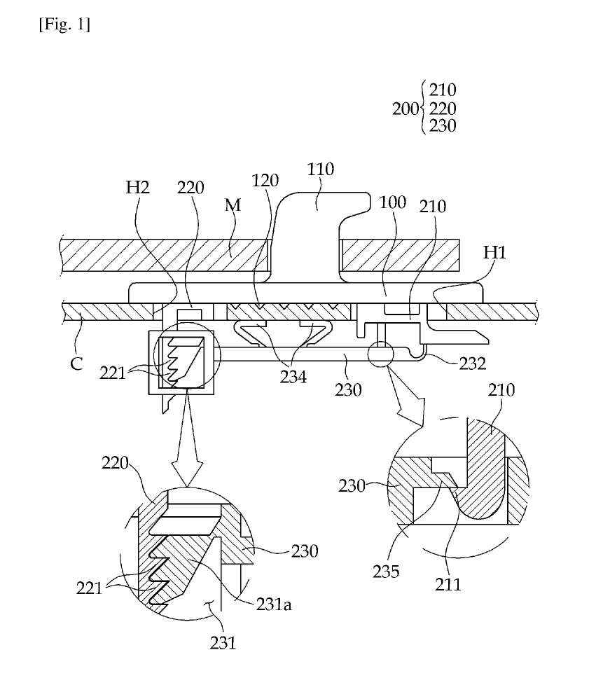

As illustrated in FIGS. 1 to 4, a clip for fixing a mat of a carpet of a vehicle according to the present invention is configured to include a body 100, one side of which has a hook 110 formed to hook the mat M, and the other side of which has a fastener 200 formed to fix the clip according to the present invention to the carpet C.

In particular, the fastener 200 is configured to include a rotation support section 210 and a fixing section 220 formed to protrude from the body 100 at a predetermined interval, and a tongue section 230 that is rotatably formed on the rotation support section 210 and one side of which is coupled to the fixing section 220 in the same manner as a cable tie. At this time, the clip is configured to be directly coupled to the fixing section 220 in a cable tie manner when the tongue section 230 is rotated.

Thus, the tongue section 230 firmly fixes the clip to the carpet to prevent the clip from being detached from the carpet C, and as the clip C is pressed, the clip can be more firmly fixed to the carpet C. Further, the tie type coupling is completed merely by rotating the tongue section 230, and thus the clip can be easily assembled to the carpet C.

Hereinafter, each component according to the present invention will be specifically described below. Here, the carpet C is manufactured by a conventional technique of mounting it in a vehicle, and two mounting holes H1 and H2 are formed to pass through the mat M and mount the clip used to fit and fix the mat M. Further, the mat M mounted on the carpet C is also manufactured by a conventional technique.

As illustrated in FIG. 1, the body 100 is configured so that the mat M may be hooked thereon while fixed to the carpet C. To this end, the hook 110 is formed on one surface (an upper surface in the drawings) to hook the mat M.

As illustrated in FIG. 1, the body 100 is formed with a plurality of pressing protrusions 120 and the fastener 200 for substantially fixing the carpet C to the other surface. The pressing protrusions 120 are pressed as the body 100 comes into close contact with the carpet C, and the pressing protrusions 120 become embedded in the carpet C like wedges to enhance the coupling force to the body 100.

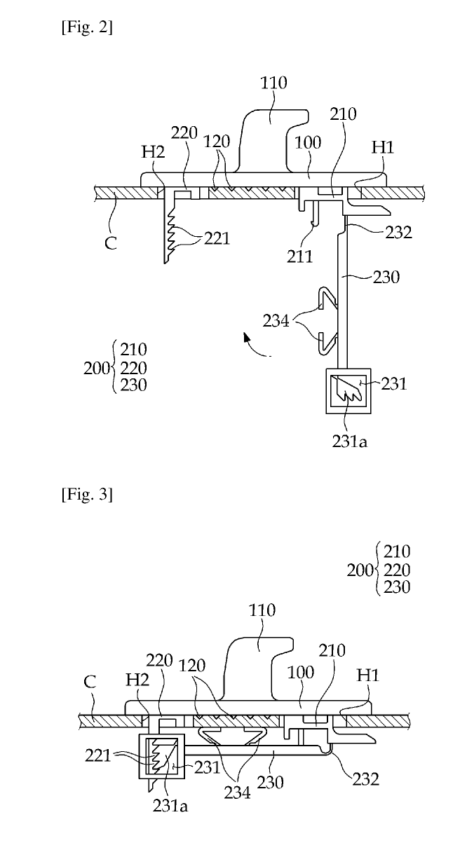

As illustrated in FIGS. 1 and 2, the fastener 200 includes the rotation support section 210 and the fixing section 220 formed to protrude from the body 100, and the tongue section 230 rotatably mounted on the rotation support section 210 and mounted to the fixing section 220 in the same manner as a cable tie to fix the carpet C. At this time, the tongue section 230 is easily mounted on the fixing section 220 in the cable tie type as it rotates about the rotation support section 210.

As illustrated in FIGS. 1 and 2, the rotation support section 210 is formed to protrude from the body 100 to be able to be inserted into the mounting hole H1 formed to pass through the carpet C. Although the rotation support section 210 may be mounted as a separate configuration by being configured separately from the body 100, it is desirable to fabricate the rotation support section 210 formed integrally with the body 100 using the same material as the body 100.

Further, a hooking jaw 211 is formed in the tip portion of the rotation support section 210 which protrudes from the body 100. At this time, the hooking jaw 211 is formed at a position that may be meshed with a hooking jaw 235 formed in a tongue section 230 to be described below when the tongue section 230 is rotated to be coupled therewith.

The tongue section 230 is mounted on the rotation support section 210 configured in this way to be rotatable toward the fixing section 220.

As illustrated in FIGS. 1 and 2, the fixing section 220 is formed in the body 100 to correspond to a position at which it may be inserted into the other mounting hole H2 formed in the carpet C. The fixing section 220 may also be formed integrally with the body 100 similarly to the rotation support section 210, or may be mounted by being separately manufactured.

In particular, a plurality of hooking jaws 221 are formed in the fixing section 220 to be hooked in one direction. At this time, the hooking jaws 221 are formed to extend toward the outside of the mounting hole H2 and may be formed at a position at which an elastic piece 231a formed in the tongue section 230 to be described below may be easily fitted thereto.

In a preferred embodiment of the present invention, the hooking jaw 221 may be formed in a shape perpendicular to a surface of the fixing section 220 or the body 100, and most preferably, the elastic piece 231a may be located on the circular arc in consideration of a radius rotating about the rotation support section 210.

As illustrated in FIGS. 1 and 2, the tongue section 230 is manufactured in the form of a strip slightly longer than the length between the rotation support section 210 and the fixing section 220. The tongue section 230 is supported by the rotation support section 210 at one end and is mounted to be rotatable in a direction of the fixing section 220.

In particular, the tongue section 230 has a tip formed with a through-hole 231 into which the hooking jaw 221 may be inserted. Then, the through-hole 231 is formed with an elastic piece 231a which serves as a stopper while being deformed as the hooking jaws 221 advance by being sequentially hooked.

In the preferred embodiment of the present invention, the through-hole 231 is desirably formed by cutting both side surfaces to which the hooking jaw 221 is fitted so that the elastic piece 231a is visible. This is because, when the elastic piece 231a is hooked by the hooking jaw 221, the hooking is not released, and when there is a need to release the hooking such as when the clip is broken or damaged and needs to be replaced with a new one, a tool such as a screwdriver is fitted to the cut portion to forcibly release the locking of the elastic piece 231a.

Meanwhile, the tongue section 230 is preferably manufactured using a flexible material so that the hooking jaw 221 can be easily inserted into the through-hole 231. At this time, it is desirable to use the same synthetic resin as the body 100 as a material, and the tongue section may be manufactured separately from the body 100 and may be fixed to the tip of the rotation support section 210 using a screw or the like, but it is preferably formed integrally with the rotation support section 210.

Moreover, in a preferred embodiment of the present invention, when the rotation support section 210 and the tongue section 230 are integrally formed, it is preferred that the connection portion be thinly connected to another portion by a weakened section 232 so that the tongue section 230 can easily rotate about the rotation support section 210.

Meanwhile, as illustrated in FIGS. 1 and 2, in the tongue section 230, another hooking jaw 235 is formed at a position that faces the hooking jaw 211. The hooking jaws 211 and 235 are engaged with each other to enhance the coupling force between the rotation support section 210 and the tongue section 230 when the tongue section 230 is rotated about one side one of the rotation support section 210 and the other side of the hooking jaw 221 is inserted into the through-hole 231.

In the preferred embodiment of the present invention, as illustrated in FIGS. 1 and 2, the tongue section 230 is desirably formed with an additional pressing piece 234 on a surface that faces the carpet C. The pressing piece 234 causes deformation between the tongue section 230 and the carpet C as the hooking jaw 221 is inserted into the through-hole 231 of the tongue section 230, and applies predetermined tension between the tongue section 230 and the carpet C, thereby obtaining an effect of preventing the clip according to the present invention from being detached from the carpet C.

### Coupling of Carpet and Mat

The clip formed as described above according to the present invention couples the carpet C and the mat M in the order illustrated in FIGS. 2 to 4.

First, the clip according to the present invention is coupled to the carpet C. As illustrated in FIG. 2, the rotation support section 210 and the fixing section 220 are inserted into the mounting holes H1 and H2, respectively, in a state in which the tongue section 230 is unfolded. The tongue section 230 rotates in a direction of the arrow in FIG. 2. At this time, the tongue section 230 easily rotates about the weakened section 232.

In this way, when the tongue section 230 is rotated, the hooking jaw 221 is inserted into the through-hole 231. Thus, the elastic piece 231 a is deformed and goes over the hooking jaws 221, and the mounting of the clip is completed as shown in FIG. 3.

At this time, the tongue section 230 fixes the carpet C more strongly while going over the plurality of hooking jaws 221 one by one, the hooking jaws 211 and 235 formed in the rotation support section 210 and the tongue section 230 are hooked, and the coupling between the rotation support section 210 and the fixing section 220 is completed.

Meanwhile, when the coupling is completed in this way, the pressing protrusions 120 are fitted to the carpet C like wedges so that the clip is not detached from the carpet C, and the pressing piece 234 provides the tension while causing the elastic deformation between the carpet C and the tongue section 230 to fix the clip and prevent detachment.

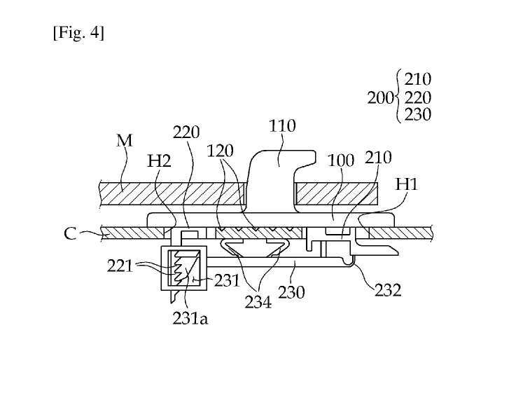

Finally, as illustrated in FIG. 4, the mat M is placed on the carpet C and the mat M is hooked by a hook 110, completing the mounting work.

In this way, as the hooking jaw 221 is formed in a shape perpendicular to the carpet C, the direction in which the load is applied from above the carpet C is similar to the formation direction of the hooking jaw 221, and thus, even when the load is applied from above the carpet C, the hooking jaw 221 is inserted into the through-hole 231 more deeply and is hooked by the elastic piece 231a to enhance the coupling force of the clip.

As described above, the present invention can prevent the clip from being easily detached from the carpet when the clip is mounted on and fixed to the carpet by adopting a method like that of a cable tie. In particular, by providing such tie coupling as the tongue section is rotated, the clip can be easily and rapidly assembled.

1-5. (canceled)

6. A clip for fixing a mat of a carpet of a vehicle comprising a body, one side of which has a hook formed to hook the mat, and the other side of which has a fastener configured to be fixed by being fitted to the carpet and a plurality of pressing protrusions configured to contact the carpet,
wherein the fastener comprises:
a rotation support section inserted into a mounting hole (H1) formed through the carpet at a predetermined position;
a fixing section that is inserted into another mounting hole (H2) formed to pass through the carpet with a predetermined gap from the mounting hole (H1), protrudes toward the outside of the mounting hole (H2), and is formed with a plurality of hooking jaws to be hooked in one direction; and
a tongue section that is formed in the rotation support section to be rotatable toward the fixing section, and has a through-hole having an elastic piece at a tip thereof, the elastic piece being elastically deformed so that the hooking jaws advance by being sequentially hooked.

7. The clip of claim 6, wherein, as the tongue section is mounted by being fitted to the fixing section, hooking jaws are formed on surfaces of the support section and the tongue section that face each other, and when the through-hole of the tongue section is mounted by being inserted to the through-hole, the hooking jaws are coupled to each other.

8. The clip of claim 6, wherein unlocking of the elastic piece is enabled by cutting both side surfaces of the through-hole through which the hooking jaw passes to pass therethrough so that the elastic piece is visible from the outside.

9. The clip of claim 6, wherein the tongue section is formed integrally with the rotation support section, and rotates by being connected by a weakened section having a thin thickness.

10. The clip of claim 6, wherein the tongue section has a pressing piece that is further formed on a surface facing the carpet to be pressed in contact with the carpet.

11. The clip of claim 7, wherein the tongue section has a pressing piece that is further formed on a surface facing the carpet to be pressed in contact with the carpet.

12. The clip of claim 8, wherein the tongue section has a pressing piece that is further formed on a surface facing the carpet to be pressed in contact with the carpet.

13. The clip of claim 9, wherein the tongue section has a pressing piece that is further formed on a surface facing the carpet to be pressed in contact with the carpet.
